(19) United States
(12) Patent Application Publication
(10) Pub. No.: US 2004/0143493 A1
(43) Pub. Date: Jul. 22, 2004

(54) Integrated network entry system

(75) Inventors: Jason Gessner, Bartlett, IL (US); Jerry Scott, Valparaiso, IN (US); Jed Weissbluth, Chicago, IL (US); Damian Kohlfeld, Chicago, IL (US); Michael Farro, Chicago, IL (US); Matthew Maday, Westchester, IL (US)

Correspondence Address: SCHIFF HARDIN, LLP, PATENT DEPARTMENT, 6600 SEARS TOWER, CHICAGO, IL, 60606-6473, US

(73) Assignee: ONCALL Interactive LLC

(21) Appl. No.: 10/348,070

(22) Filed: Jan. 21, 2003

(51) Int. Cl. G06F 17/60

(52) U.S. Cl. 705/14

(57) ABSTRACT

A method and apparatus for operating a sweepstakes includes an online component permitting entry into the sweepstakes by a user via an Internet connection to a World Wide Web site. A telephone component is also provided that receives telephone calls from participants and via an interactive voice response system permits the participants to enter the sweepstakes. As a condition of entry, the participants via either component are requested to provide information, which is stored and combined to provide a database of information on the participants of both the online component and the telephone component. Registration, including warranty registration, may also be provided using the integrated network system.

### BACKGROUND OF THE INVENTION

1. Field of the Invention

The present invention relates generally to a method and system for receiving and processing data over an integrated network, and particularly to conducting a sweepstakes or promotion related to a product, brand, service or company via an integrated communications network.

2. Description of the Related Art

Sweepstakes are a popular means for promoting sales of a product or service. As used herein, “Sweepstakes” are a type of incentive award program or contest intended to promote the sales of a company's products or services by a promotional game offering prizes, such as the products or services of the sponsoring company, to the sweepstakes participant. The terms “user” and “participant” are used interchangeably herein to designate a person who enters or desires to enter a sweepstakes. The sweepstakes incentive program may seek to direct consumers to purchase the products or services of the sponsoring company, to view advertising, or to test a product. The sweepstakes may promote awareness of the company's products, services and/or brands, introduce new products, introduce a newly identified audience to the products or services, and accomplish other commercial purposes. Most commonly, sweepstakes are used to generate additional sales revenue and better understand the customer through the collection of demographic data (e.g. mailing address or gender) requested in the sweepstakes participation process.

Historically, sweepstakes have required entry via independent and unrelated communications channels such as mail, or the publicly switched telephone network, or the Internet. Each separate communications channel has its respective costs to the sweepstakes sponsor: for mail entries, labor-related costs to conduct sweepstakes are typically substantial, as each entry must be reviewed, checked and entered into an information system, particularly if demographic information on the participants is desired; for telephone entries, the ability to receive and process a large volume of calls has typically resulted in significant costs related to telecommunications equipment and service, or high staffing costs for call centers, or both; and for Internet entries, the primary costs are often related to software development, connectivity to the Internet, and hardware. In general, telephone and Internet entries are the preferred methods for sweepstakes sponsors because they provide immediate user gratification and lower cost relative to mail entries.

With regard to the participant's convenience, each communications channel has its respective drawbacks. Mail entries require writing, postage, and lack immediacy due to the passage of time inherent to the process of delivery by the mail carrier. Telephone entries require the participants to use a telephone service and incur telecommunications expense. Internet entries require Internet access and familiarity with online sweepstakes. In general, telephone and Internet entries are the preferred methods for participants because they provide immediate gratification and lower cost relative to mail entries.

### SUMMARY OF THE INVENTION

The present invention provides a method and system for conducting a product promotion, such as a sweepstakes, using both a network connection via the Internet and a network connection via the telephone system. The present invention uses (1) an Internet-based system, or other online system, for communication with participants that have or use Internet services, and (2) incorporates as a second component, an automated telephone system for communication with participants who wish to use the telephone as an alternative to the Internet-entry method. It should be appreciated that the present invention receives Internet-based and telephone-based entries without regard to the method of transmission, whether by wireless telephonic signal, satellite signal, so-called instant messaging technologies, or other transmission methods utilizing the Internet or telephone systems. The present invention provides these two entry or participation methods in part for the added convenience of the participant and in part for the reduced cost of the sweepstakes sponsor. An additional benefit of the present invention is that important demographic data related to sweepstakes participants is collected, organized, stored, manipulated, and interpreted without substantial labor-related costs. Both online and telephone participants participate equally, and participant information is automatically collected from both classes of participants.

The invention relates to a method and to software and related services for providing product promotions, such as by sweepstakes.

### BRIEF DESCRIPTION OF THE DRAWINGS

FIG. 1 shows a flow chart showing one embodiment of a method according to the present invention; and

FIG. 2 is a block diagram of the arrangement for carrying out the method of the present invention; and

FIG. 3 is a schematic illustration of the apparatus according to a preferred application of the invention.

### DETAILED DESCRIPTION OF THE PREFERRED EMBODIMENTS

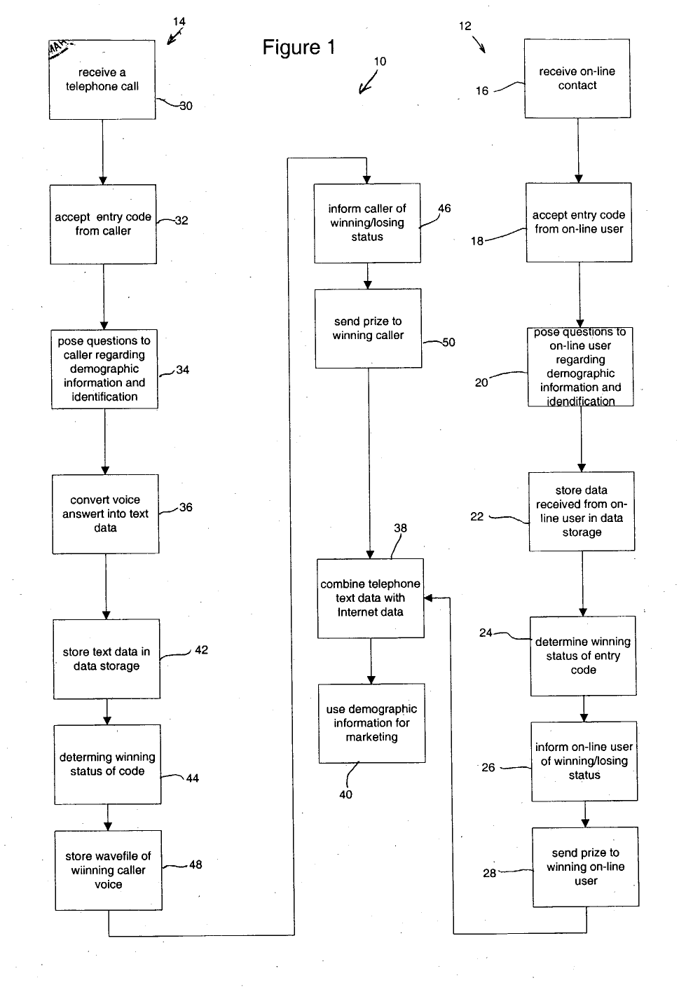

Referring first to FIG. 1, the present method provides a network-integrated sweepstakes 10 that permits a company to offer an instant win sweepstakes to consumers of, for example, mass-market goods and services. The integrated sweepstakes 10 includes an online component 12 and a telephone component 14, as indicated by the two entry points for the present method. A user of either system has received information about the sweepstakes from the sweepstakes organizer, either by mail, television or radio advertising, online advertising, product packaging, handouts, or otherwise. The information received by the user includes an Internet address, such as a World Wide Web address, and/or a telephone number. The information also includes an entry code that may be unique to the user. “Entry code” as used herein may be an alphanumeric code that is provided to the user, or may instruct the user to utilize as the code an alphanumeric code that the user already knows or possesses, such as the user's telephone number, social security number, driver's license number, etc. Alternatively, the information received by the user may be unique to the product, such as a UPC code, and by way of example, and not limitation, entry processes such as retinal scanning process, finger print analysis or security tokens (e.g., access cards) may be used. The user enters the sweepstakes either by telephone at 14 or online communication at 12 with the entry code, the “Entry Process.” In any event, the sweepstakes sponsor typically seeks to link a participant's specific entry to that particular participant in the course of the Entry Process for tracking and award fulfillment purposes, although it should be appreciated that the present invention could utilize any suitable entry processes.

Participants who chose to utilize the online component access an Internet site 16, for example, on the World Wide Web, for the sweepstakes promotion where they are asked at 18 to enter a sweepstakes entry code. The sweepstakes entry code may have been obtained by the user from a product package, advertisement, or other distribution means. For example, a direct marketing company may provide mailings to some participants and on-package information to other participants.

Upon successful entry of the entry code information, the user is asked at 20 to enter demographic information and/or personal identification information. The demographic information may be age, economic status, community or region, etc., which information is desired by the sweepstakes operator to facilitate an understanding of prospective customers. The user-entered information is stored digitally at 22 in electronic data storage as text, and is preferably sorted into a database.

The winning/losing status of the entry code is checked at 24 and the status is reported to the participant, or user, immediately at 26. The participant or user knows immediately if he or she is a winner, or in the alternative, is entered into a contest drawing conducted at a later date. The participant may also be informed of the prize for submitting the winning entry code. As such, the participant has immediate gratification for utilizing the online sweepstakes system.

Of course, the sweepstakes generally has different prize levels, and some users will win a lesser prize than others. For some prizes, it may be possible to transmit at 28 the winning prize information directly to the user via e-mail, such as a prize claim code, cash transfer code, or the like.

Entry of a losing code is also immediately reported to the participant, usually with encouragement to try another entry, or the user is offered a chance to participate in an online game or other activity. The losing participant may also be offered a discount coupon for the goods or service.

Not all consumers have access to Internet services and even some that do have access are not comfortable in using an online service. As such, the present sweepstakes system includes a telephone component at 14. In the preferred embodiment, the user calls a telephone number at 30 and either an automated attendant answers the call or a audible messaging system prompts the user to manually enter numeric telephone digits in response to pre-recorded messages. The telephone user is given the opportunity to input an entry code at 32, either by speaking or pressing the telephone keypad buttons.

The automated attendant uses an interactive voice response system to ask the user a series of questions at 34 and to record the user responses. The questions may be the same as those posed to the user of the online service, relating to identification and demographic information, for example. The responses of the user are translated by a voice recognition component at 36 and stored at 42 as text into a data storage device, and preferably sorted into a database. In one embodiment, the data storage for the telephone data is the same data storage as is used for the online component. In another embodiment, the data from the telephone users and the data from the online users are kept separate and are later combined into a single database at 38. The combined data is then available for current and future marketing purposes, analyzing the effectiveness of other concurrent marketing efforts, and for other business purposes as indicated at 40.

The winning status of the code is determined at 44. The user is immediately informed at 46 of the winning or losing status of the entry attempt. For verification purposes, the voice data of the winning telephone user may be recorded and stored as an audio file at 48. One example of such an audio file is a waveform file, although other file types are of course possible.

After entry of a winning code, the users are sent a prize, as indicated at 50. This may include notification of the winning status and/or the prize by e-mail for online users or by telephone for telephone users. The data collected by the sweepstakes promotion may be studied to determine effectiveness of a marketing campaign, to determine consumer response to a product or service, to conduct marketing analysis, or for other business purposes.

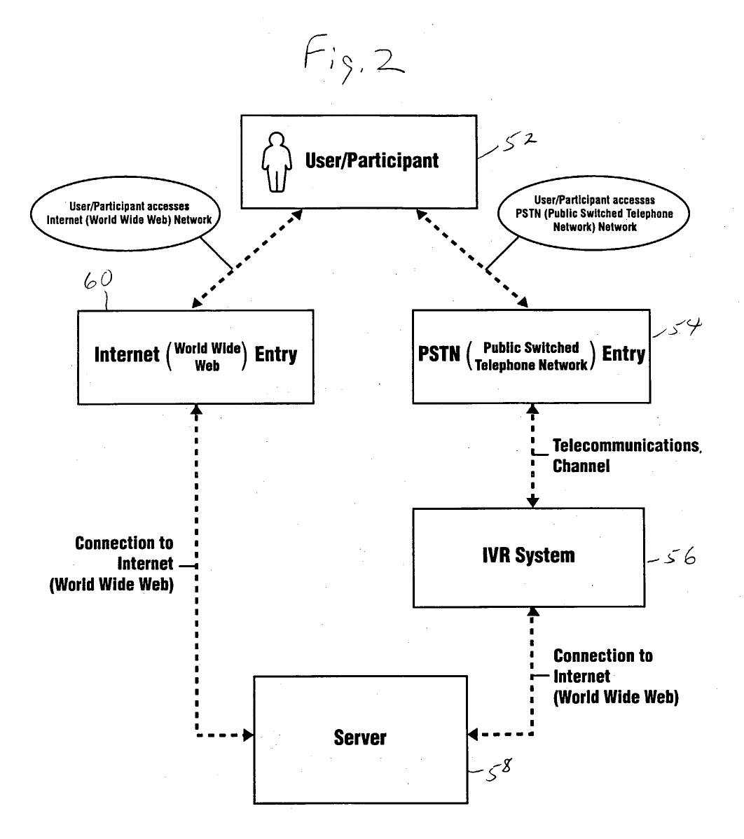

FIG. 2 presents an overview of the arrangement for carrying out the method of the invention. A user or participant 52 has two options for entry to the network according to the invention. The user 52 may use a public telephone system 54 to dial a telephone number that puts the user into voice communication with an Interactive Voice Response (IVR) system 56. The voice recognition system 56 answers the call, asks questions and determines the voice responses of the user, such as to enter a sweepstakes, register a product, etc. The voice recognition system 56 communicates with a server 58 where data relating to the call, including the answers provided by the user 52, are stored.

The user 52 may instead connect to the network services via an Internet entry 60. The user uses the World Wide Web (WWW) of the Internet to access a web site using a URL (Uniform Resource Locator) such as provided on the sweepstakes notice or product registration form. The user 52 web site interface asks questions of the user and records the answers. The questions may be the same as those asked via the telephone system, or may be different. The user information is available to the server 58 via either communication pathway.

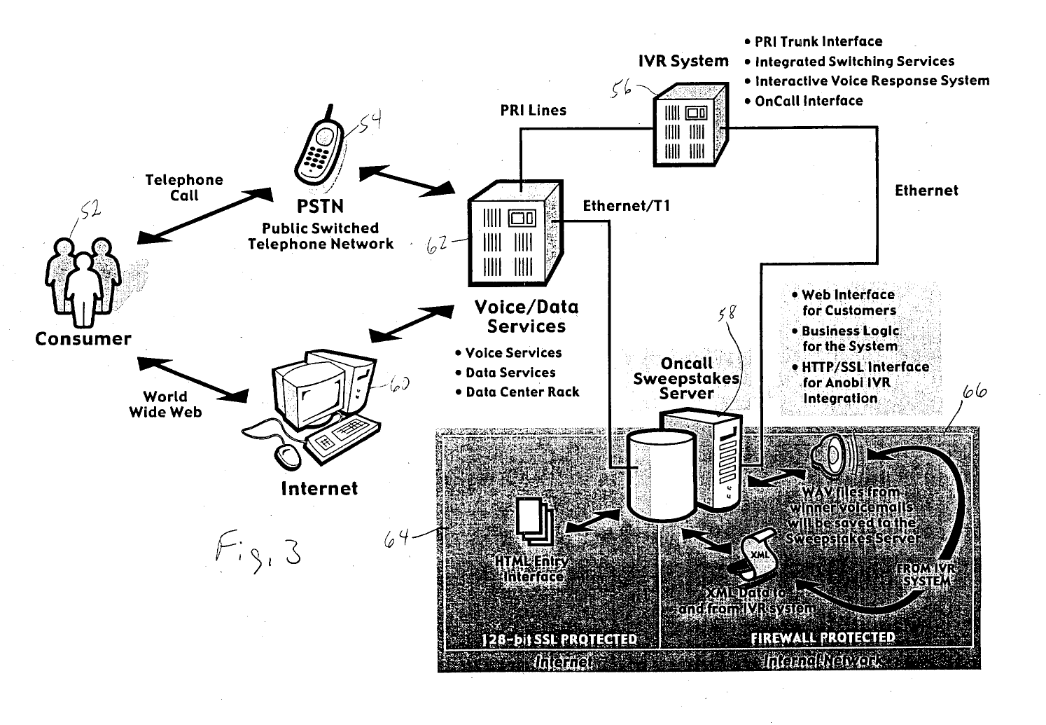

In detail, FIG. 3 shows the users 52, who are here referred to as consumers, who may either make a telephone call on the public switched telephone network 54 to a voice and data service 62 or may utilize the World Wide Web of the Internet 60 to access the voice and data services 62. The voice and data services 62 has voice services, data services and a data center rack. In the preferred embodiment, the communication with the users that are calling on the telephone system is sent via PRI lines 64 to the IVR system (Interactive Voice Response system) 56, although it should be noted that other telecommunications hardware and channels could be used to the same effect. The IVR system 56 has a PRI trunk interface, integrated switching services, an interactive voice response software and a proprietary software interface.

Both the voice and data service 62 and the IVR system 56 are connected via a network connection to the server 58 of the sweepstakes services provider. For example, the network connection may be via an Ethernet connection, or via a Ti line. The sweepstakes services provider server 58 has an Internet portion 64 with an HTML entry interface that is protected by, for example, a 128-bit SSL protection. As used herein, “HTML” refers to Hypertext Markup Language and “SSL” refers to Secure Sockets Layer. The data from the IVR system 56 is communicated as XML data to the internal network as indicated at 66, which resides behind a firewall. The sweepstakes services provider's server 58 also stores a waveform recording of the winning user's voice on the telephone.

The telephone component may include fraud protection means, such as a voice imprint detector or a telephone number verification system. Fraud protection may be present in the Internet component as well. For example, an IP (Internet Protocol) address verification system may be included. Since the entries in both systems are made electronically, there is no need to check physical game pieces for alteration and the instance of fraud is reduced through hardware and software network-based security protocols.

The sweepstakes server provides a web interface for the sweepstakes sponsor to view data related to the sweepstakes while in progress, provides the business logic for the system, and has an HTTP/SSL interface for integration with the IVR system for administrative purposes.

The sweepstakes system provides a promotional offering related to a product, brand, service or company, and by integrating the Internet and telephone system data enables the promoter to increase sales, obtain demographic information, evaluate the effectiveness of advertising, and support prize fulfillment, among other business objectives. The scope of the promotional activity is increased by spanning two different and convenient entry channels at typically lower cost to the promoter than mail-based entries. The sweepstakes provides data on return on investment, cost of customer acquisition, effectiveness of advertising in various media, and other economic data.

By integrating the telephone and Internet sweepstakes entry channels, a wider variety of users can participate in the promotion easily and conveniently. Telephones, including mobile telephones, are the most widely available electronic device, even though the Internet is becoming more widely accepted as a mass-market communication tool. Both of these popular communications means is used in this sweepstakes system. By eliminating mail entries for both Internet-using participants and Internet-adverse participants, both types of participants have equal access to the instant win sweepstakes. Older or economically disadvantaged users have equal access to the sweepstakes, and so the participation is more likely to reach a broader pool of participants than a sweepstakes limited to one communication system.

Labor for prize fulfillment, processing of paper entries and the like are eliminated for the provider of the sweepstakes. Manual entry of the data is no longer required. No call centers need to be staffed. For the sweepstakes participant, the cost and time for preparation and mailing of the entry, including paper and postage, is eliminated.

The data from the telephone and Internet entries is merged into a single database and is treated equally. Full reporting of the data is possible including demographic information of the participants, prize status, participation level, call volume, web entries, and all other activity. Live updates of the data during the running of the sweepstakes are possible through proprietary administrative tools. It is even possible to monitor the sweepstakes through these tools while it is running and to make changes to it so as to improve its reach and effectiveness.

The reports generated from the data collected during the running of the sweepstakes may be on paper (hardcopy) or in electronic form. E-mail notification of various events and thresholds is also possible. The data may be manipulated, aggregated, detailed, summarized and observed at any time.

The usefulness of any advertising campaign being run with the sweepstakes can be measured by monitoring of the entries.

The telephone sweepstakes system of one embodiment collects the telephone number data of the callers, either automatically or as a condition of entry. It is thus possible to monitor the effectiveness of the promotional campaign on a regional basis using the telephone data. Advertising resources can then be dedicated to the area of greatest effect.

The IVR system of the present telephone sweepstakes component may be, alternatively: only voice recognition, only manual digit entry, or voice recognition supplemented by a manual digit entry system by the caller. For participants that utilize the online entry system, the notice of winning status may be sent to them via e-mail, thereby avoiding the necessity of contacting the winners via mail or by phone. The e-mail status communication may be sent automatically by the present sweepstakes system.

In an embodiment of the invention, the purchaser of goods may use the integrated telephone and web system to submit a product registration and/or warranty registration. The warranty and/or product registration may be automated, and can be used by the purchaser of the goods in addition to or instead of submitting an entry for the sweepstakes or contest. In particular, the goods may be packaged with a warranty registration slip which directs the purchaser, see the user 52 in FIG. 2, to either call the manufacturer or agent of the manufacturer, as shown at 54, or log onto the Internet site, as shown at 60, to register the purchase. The purchaser's demographic information is input into by the purchaser via either the telephone system 54 or the Internet site 60 and is stored in a server 58 so that the manufacturer does not have to enter information written on a warranty card received in the mail from the purchaser. The purchaser information received by mail from some purchasers and that received via the Internet site 60 from other purchasers and by telephone 54 from yet other purchasers is combined to a common database on the server 58, according to the present invention. In this aspect, the present invention provides an integrated registration system.

In an even broader view, the present invention provides a network entry system into a computer network via either a computer network entry point or via a telephone entry point. Data collected from both entry points is available for further use.

The registration may be for a variety of product purchase, such as household appliances, personal care products, and electronics such as music systems and components. The product warranty and/or registration process may be used not only for recording and tracking registered users of products, but also can be used for service plans, product promotions, promotions of related products, cross-selling, direct marketing, and other business purposes.

The product registration may be tied to a sweepstakes, for example, as an added incentive for the purchaser to contact the manufacturer via either telephone or the Internet. The purchaser contacts the manufacturer either by telephone or by the Internet and enters the sweepstake and is also given the opportunity to register the product purchase. On the other hand, the product registration process may stand alone without a sweepstakes.

The integrated system of the present invention may be used for a variety of registration situations.

For purposes of the present invention, “registration” includes product registration, warranty registration, customer registration, subscription registration, etc.

Although other modifications and changes may be suggested by those skilled in the art, it is the intention of the inventors to embody within the patent warranted hereon all changes and modifications as reasonably and properly come within the scope of their contribution to the art.

We claim:

1. A network integrated sweepstakes method, comprising the steps of:
receiving a sweepstakes entry at an Internet site from an online user, including:
posing questions to the online user regarding identification and demographic information via text at an Internet site;
storing answers as text input by the online user to the questions at least with respect to the demographic information from the online user;
accepting a sweepstakes entry code from the online user;
determining a winning/losing status of the entry code received from the online user;
reporting the winning/losing status to the online user;
receiving a sweepstakes entry via voice signal or via the manual entry of digits over a telephone connection from a telephone user, including:
posing questions to a telephone user regarding identification and demographic information using voice generation;
receiving answers to the questions as voice signals or manually entered digital signals from the alphanumeric entry pad from the telephone user;
converting the telephone user's answers to text or to another suitable digital format;
storing answers to the questions as text or in another suitable digital format at least with respect to the demographic information from the telephone user;
accepting a sweepstakes entry code from the telephone user;
determining a winning/losing status of the entry code received from the telephone user;
reporting the winning/losing status to the telephone user;
combining data from the telephone user with data from the telephone user into a single database.

2. A network integrated sweepstakes method as claimed in claim 1, further comprising:
storing voice data from at least a winning telephone user as a waveform file.

3. A network integrated sweepstakes method as claimed in claim 1, wherein said step of combining data of a telephone user and of an online user is performed as the data is received from the respective users.

4. A network integrated sweepstakes method as claimed in claim 1, wherein said step of combining data of a telephone user and of an online user is performed at completion of a sweepstakes.

5. A network integrated sweepstakes apparatus, comprising:
a telephone answering apparatus connected to a public switched telephone system;
an interactive voice response system connected to said telephone answering apparatus and operable to pose questions to a telephone user and to convert voice answers or manually entered digits to text data;
a telephone data storage connected to said interactive voice recognition system for storing said text data from the telephone user;
a server connected to the Internet, said server having pages posing questions and accepting answers at text input by an telephone user; and
a telephone data storage connected to said server for storing text input from the telephone user.

6. A network integrated sweepstakes apparatus as claimed in claim 5, further comprising:
a voice and data interface connected between said interactive voice response system and the telephone network and connected between said server and the Internet.

7. A network integrated sweepstakes apparatus as claimed in claim 5, wherein said telephone data storage and said online data storage are the same.

8. A network integrated registration apparatus, comprising:
telephone answering apparatus connected to a public switched telephone system;
an interactive voice response system connected to said telephone answering apparatus and operable to pose questions to a telephone user and to convert voice answers or manually entered digits to text data;
a telephone data storage connected to said interactive voice recognition system for storing said text data from the telephone user;
a server connected to the Internet, said server having pages posing questions and accepting answers at text input by an telephone user; and
a telephone data storage connected to said server for storing text input from the telephone user.

9. A network integrated method for registration, comprising the steps of:
receiving a registration entry at an Internet site from an online user, including:
posing questions to the online user regarding identification and demographic information via text at an Internet site;
storing answers as text input by the online user to the questions at least with respect to the demographic information from the online user;
accepting a registration entry code from the online user;
receiving a registration entry via voice signal or via the manual entry of digits over a telephone connection from a telephone user, including:
posing questions to a telephone user regarding identification and demographic information using voice generation;
receiving answers to the questions as voice signals or manually entered digital signals from the alphanumeric entry pad from the telephone user;
converting the telephone user's answers to text or to another suitable digital format;
storing answers to the questions as text or in another suitable digital format at least with respect to the demographic information from the telephone user;
accepting a registration entry code from the telephone user;
combining data from the telephone user with data from the telephone user into a single database.
